(19) United States
(12) Patent Application Publication
(10) Pub. No.: US 2011/0182205 A1
(43) Pub. Date: Jul. 28, 2011

(54) METHOD AND APPARATUS FOR SERVICE DISCOVERY

(76) Inventors: Martin Gerdes, Monschau-Rohren (DE); Andreas Fasbender, Aachen (DE); Andreas Häber, Arendal (NO); Frank Reichert, Grimstad (NO)

(21) Appl. No.: 12/521,672

(22) PCT Filed: Oct. 15, 2007
(86) PCT No.: PCT/SE07/50740

§ 371 Date: Feb. 24, 2011

Related U.S. Application Data
(60) Provisional application No. 60/882,303, filed on Dec. 28, 2006.

(51) Int. Cl. H04L 12/28

(52) U.S. Cl. 370/254

(57) ABSTRACT

A method and apparatus for conducting remote discovery of services across different local networks. A service discovery gateway in one local network issues a request for discovery information on the services in the opposite local network, embedded in a presence subscribe message over an IMS network. Discovery information is then received in a generic format embedded in a presence notify message over the IMS network. The received discovery information has been collected by a service discovery gateway in the first local network using a local service discovery protocol in the first local network. The received discovery information is announced to devices in the second local network, using a local service discovery protocol valid within the second local network. Thereby, local services can be provided and utilized across different local networks, even when different device-specific service discovery protocols are used within the local networks.

### TECHNICAL FIELD

The present invention relates generally to a method and apparatus for enabling remote discovery of services and communication devices across different local networks, to enable communication of media with a device in one local network from a device in another opposite local network.

### BACKGROUND

A multitude of different types of communication terminals, sometimes referred to simply as “devices”, have been developed for packet-based multimedia communication using IP (Internet Protocol). Multimedia services typically entail transmission of media in different formats and combinations over IP networks. For example, an IP-enabled mobile terminal may exchange media such as visual and/or audio information with another IP-enabled terminal, or may download media from a content server over the Internet.

A network architecture called “IP Multimedia Subsystem” (IMS) has been developed by the 3^{rd} Generation Partnership Project (3GPP) as a platform for handling and controlling multimedia services and sessions, commonly referred to as the IMS network. Thus, an IMS network can be deployed to initiate and control multimedia sessions for IMS-enabled terminals connected to various access networks, regardless of the access technology used. Although conceived primarily to enable multimedia services for mobile IP terminals, the IMS concept can also be used for fixed IP terminals.

Multimedia sessions are handled by specific session control nodes in the IMS network, e.g. the nodes P-CSCF (Proxy Call Session Control Function), S-CSCF (Serving Call Session Control Function), and I-CSCF (Interrogating Call Session Control Function). Further, a database node HSS (Home Subscriber Server) is used in the IMS network for storing subscriber and authentication data. The IMS network may also include various application servers for providing different multimedia services, such as presence services where terminal users can subscribe to various published information on other users.

According to the IMS platform, the control protocol called “SIP” (Session Initiation Protocol) is utilised to initiate, operate and terminate multimedia sessions. Standard SIP messages can thus be used by IP terminals or devices for establishing multimedia sessions, such as the session initiating message “SIP invite” and the common response message “SIP 200 OK”.

In SIP, the “Session Description Protocol” can also be used, embedded as a self-contained body within SIP messages, to specify different communication parameters needed for a forthcoming multimedia session. This protocol is generally used to provide necessary information in session setup procedures, e.g. device capabilities, media properties, currently used IP addresses, etc., as is well-known in the art.

It is desirable to generally provide IMS-based services also for devices in a limited IP based local or private network such as a residential or office network, also referred to as a LAN (Local Area Network) or PAN (Personal Area Network). In this description, the generic term “local network” is used to represent any such networks, and the term “device” is used to represent any terminal capable of IP communication within the local network. In such local networks, a local IP address is allocated to each device for communication within the network which, however, cannot be used for routing messages and data outside that network.

The devices in a local network may include fixed and wireless telephones, computers, media players, servers and television boxes (the latter often referred to as a Set Top Box, STB). In order to provide IMS services to devices in the local network, a multimedia gateway called “Home IMS Gateway, HIGA” has been defined that can emulate an IMS terminal from the local network towards the IMS network, to access IMS services on behalf of any device in the local network.

UPnP (Universal Plug-and-Play) is an architecture developed in a multi-vendor collaboration called the UPnP Forum, for establishing standard device protocols for the communication between different IP devices in a local network using different access technologies, operating systems, programming languages, format standards and communication protocols. UPnP provides standardised methods to describe and exchange device profiles that include capabilities, requirements and available services in the devices.

UPnP also supports a process called “discovery” (or “pairing”) in which a device can join a local network, obtain a local IP address, announce its name and IP address, and exchange capabilities and services with other devices within the network. In the following description, the term “discovery information” represents any such information such as name, identity, local IP address, URI (Universal Resource Identifier) for stored media content, device capabilities and available services, communicated between the devices during a discovery process. The discovery process can also be conducted within a temporarily formed ad-hoc network, e.g. using Bluetooth communication.

For Bluetooth, a Service Discovery Protocol (SDP) has been standardised for finding devices and their services in the discovery process. The device capabilities and available services can be specified in a Service Discovery Application Profile (SDAP), as utilised by the SDP. For networks using other communication protocols, such as ZigBee and IrDA (Infrared Data Association), similar device profiles and service discovery mechanisms have been defined.

DLNA (Digital Living Network Alliance) is a standardisation organisation that develops interworking guidelines for acquiring, storing and accessing digital media content from devices in a local network. The UPnP protocol is utilised by DLNA as an underlying protocol for communication between devices within local networks.

An architecture for enabling remote access will also be defined, where remote “UPnP devices” located outside the local network can communicate media with devices within the network. In WO 2006/079891 (Nokia), a solution is described for setting up a VPN (Virtual Private Network) tunnel as a data/media transport channel for such remote UPnP access, e.g. using IPSec (IP Security). However, this solution requires the use of IP address resolution and DNS (Domain Name server) technology, as well as access to a dynamic DNS client in the private network.

In FIG. 1, a local network 100 is shown with different devices in a family residence or an office. As shown here, these devices include a wireless telephone, a fixed telephone, a TV apparatus, a laptop computer, and a media server. The network 100 also includes a conventional gateway 102 connected to an external access network 104 to provide a communication link to other networks for the devices, referred to as a “residential gateway RGW”. The RGW 104 typically includes a NAT (Network Address Translation) function and a local DHCP (Dynamic Host Configuration Protocol) server allocating local IP addresses to the devices, as is well-known in the art.

The local network 100 further includes a HIGA 106 providing a connection to an IMS network 108 in which an HSS 110 is shown. The HIGA 106 has suitable interfaces towards the different devices in network 100, using device-adapted protocols. The HIGA 106 may be integrated in the RGW 102, but logically it will be considered as an individual functional unit in this description.

The HIGA 106 holds IMS identity information 112 associated with IMS subscriptions and user/service profiles, which can be used for accessing the IMS network 108 where corresponding subscriber information 114 is stored in the HSS node 110. Accordingly, a user can log on to the IMS network from a specific used device in the local network 100 by means of HIGA 106, and the local IP address of that used device will then be associated with the user's profile. In WO 2006/045706 (Ericsson) it is described how devices in a local network can obtain IMS services by means of a HIGA.

When HIGA 106 receives a request for a multimedia service from a device in network 100 using a device-specific interface/protocol, HIGA 106 translates the service request into a valid IMS request (e.g. SIP invite) on behalf of the device, to set up a session for the device by communicating suitable SIP messages with the IMS network 108, accordingly. In a similar manner, an IMS session can be set up by HIGA 106 for an incoming request for communication with a device in network 100, by using an IMS identity 112 associated with the device. In either case, communicated media is routed during the session from or to the device over the RGW 102 and the access network 104, as indicated by two-way arrows.

FIG. 1 further illustrates that a local device 100a moves outside the network 100 to become a remote device 100a′. The remote device 100a′ can then send a SIP invite message to the HIGA 106 over the IMS network 108 to initiate media communication with one of the remaining devices in network 100. The remote device must then have a valid IMS identity for accessing the IMS network.

In order to communicate with a device in a local network from a remote device located outside the network, the remote device must first gain knowledge of the other device, and vice versa, in a discovery process. Once a device has executed the discovery process in a local network, it has knowledge of the local IP-address, name and capabilities/services of other devices in that network. The devices can then exchange media content inside the network, but not outside since the local IP address cannot be used. Thus, should a device move out of the local network and connect to some other network, it can no longer interact with the local devices in the first network in this manner and discovery messages cannot be exchanged remotely.

Moreover, when a device belonging to a first local network moves to a second local network using an allocated local IP address for communication in the second network, it is not possible to conduct a discovery process remotely with devices in the first local network. Therefore, the remote device cannot find devices and services in the first local network, nor announce itself and its services to the first network, when located in the second local network.

It would be complicated and difficult to realise applications on a single device that can obtain and use information on services in a remote network and also discover local services in a currently connected network, and further provide discovery information on the local services to the remote network. Today, no solution exists for discovering and utilising services across different local networks that use different service discovery protocols (SDPs), as the different SDPs are not compatible to each other. For example, a device that only supports a UPnP-based SDP for service discovery cannot utilise any Bluetooth service provided by another device, neither remotely from another local network nor locally within the same network.

For example, it would be desirable to discover services and devices in a remote network from a device (e.g. a mobile IMS phone) located in another local network, in order to utilise a service in a device (e.g. a media server) in the remote network basically in the same manner as service consumers would do within that network. It may also be desirable to provide information about services and devices discovered in the current local network to a remote local network, so that the local services can be utilized from service consumers within the remote network.

### SUMMARY

It is an object of the present invention to address at least some of the problems outlined above. Further, it is an object to provide a solution for the discovery of devices and/or services across different local networks to enable multimedia sessions. These objects and others may be obtained by providing a method and apparatus according to the independent claims attached below.

According to one aspect, a method is provided to enable remote discovery of services and devices in a first local network from a location within a second local network, as executed by a service discovery gateway in the second local network. In this method, a request is issued for discovery information on the devices in the first local network, the request being sent embedded in a presence subscribe message over an IMS network. In response to the request, discovery information is received in a generic format embedded in a presence notify message over the IMS network. The received discovery information has been collected by a service discovery gateway in the first local network in a discovery process using a local service discovery protocol valid within the first local network. The received discovery information is then announced to at least one device in the second local network, using a local service discovery protocol valid within the second local network.

According to another aspect, a service discovery gateway is provided for conducting remote discovery of services and devices in a first local network from a location within a second local network, where the service discovery gateway is connected to the second local network. The service discovery gateway comprises a presence watcher unit adapted to issue a request for discovery information on the devices in the first local network, where the request is sent embedded in a presence subscribe message over an IMS network. The presence watcher is further adapted to receive discovery information embedded in a presence notify message over the IMS network in response to the request. The received discovery information has been collected by a corresponding service discovery gateway in the first local network using a local service discovery protocol valid within the first local network. The service discovery gateway of the second local network further comprises an announcing unit adapted to announce the received discovery information to at least one device in the second local network, using a local service discovery protocol valid within the second local network.

The service discovery gateway of the second local network further may comprise a translator adapted to translate the discovery information from the generic format into a local format supported by the second local network, before being announced in the second local network.

Different embodiments are possible in the method and service discovery gateway of the second local network above. For example, the discovery information may further be translated from the generic format into a local format supported by the second local network, before being announced in the second local network.

The request for discovery information may be sent to the service discovery gateway in the first local network, and the discovery information is then received as a response from that service discovery gateway. Alternatively, the request for discovery information may be sent to a presence server in the IMS network, and the discovery information is then received as a response from that presence server. In the latter case, the presence server may have received the collected discovery information in a presence publish message from the service discovery gateway in the first local network.

In practice, the second local network could be an ad hoc network and the service discovery gateway in the second local network could be implemented in a user device acting as a multimedia gateway to access the IMS network on behalf of other devices in the ad hoc network. In that case, a portable IMS gateway “PIGA” may also be implemented in the user device.

According to yet another aspect, a method is provided to enable remote discovery of services and devices in a first local network from a location within a second local network, as executed by a service discovery gateway in the first local network. In this method, discovery information of the services and devices in the first local network is collected in a discovery process using a local service discovery protocol valid within the first local network. The collected discovery information is then provided in a generic format embedded in a presence message over an IMS network, thereby enabling a service discovery gateway in the second local network to announce the discovery information to at least one device in the second local network, using a local service discovery protocol valid within the second local network.

According to yet another aspect, a service discovery gateway is provided for enabling remote discovery of services and devices in a first local network from a location within a second local network, where the service discovery gateway is connected to the first local network. The service discovery gateway of the first local network comprises a discovery unit adapted to collect discovery information of the services and devices in the first local network in a discovery process using a local service discovery protocol valid within the first local network. The service discovery gateway further comprises a presence presentity unit adapted to provide the collected discovery information in a generic format embedded in a presence message over an IMS network, thereby enabling a service discovery gateway in the second local network to announce the discovery information to at least one device in the second local network, using a local service discovery protocol valid within the second local network.

The service discovery gateway of the first local network may further comprise a translator adapted to translate the discovery information obtained in a local format into the generic format, before being provided over the IMS network.

Different embodiments are possible in the method and service discovery gateway of the first local network above. For example, the presence message may be sent as a presence notify message to the service discovery gateway in the opposite second local network. Alternatively, the presence message may be sent as a presence publish message to a presence server in the IMS network.

According to yet another aspect, a presence server is provided in an IMS network for enabling remote discovery of services and devices in a first local network from a location within a second local network. The presence server comprises an event state compositor adapted to receive discovery information on devices in the first local network, in a generic format embedded in a presence publish message from a service discovery gateway connected to the first local network. The presence server further comprises a presence agent adapted to receive a request for the discovery information, embedded in a presence subscribe message, from a service discovery gateway connected to the second local network. The presence agent is further adapted to send the discovery information embedded in a presence notify message to the service discovery gateway in the second local network in response to the request, thereby enabling the service discovery gateway in the second local network to announce the discovery information to at least one device in the second local network, using a local service discovery protocol valid within the second local network.

Further possible features and benefits of the present invention will be explained in the detailed description below.

### BRIEF DESCRIPTION OF THE DRAWINGS

The invention will now be explained in more detail by means of preferred embodiments and with reference to the accompanying drawings, in which:

FIG. 1 is a schematic view illustrating a local network when a remote device accesses the network from a location outside the network, according to the prior art.

FIG. 2 is a schematic network overview illustrating procedures for service and device discovery across two different local networks, in accordance with different embodiments.

FIG. 3 is a flow chart illustrating a procedure for enabling remote discovery across two opposite local networks, in accordance with one embodiment.

FIG. 4 is a signalling diagram illustrating how the inventive solution can be implemented in the peer-to-peer case, in accordance with another embodiment.

FIG. 5 is a signalling diagram illustrating how the inventive solution can be implemented in the IMS-centric case, in accordance with yet another embodiment.

FIG. 6 is a schematic block diagram illustrating two service discovery gateways in opposite local networks when using the peer-to-peer method for remote discovery, in accordance with yet another embodiment.

FIG. 7 is a schematic block diagram illustrating two service discovery gateways in opposite local networks when using the IMS centric method for remote discovery, in accordance with yet another embodiment.

FIG. 8 is a schematic block diagram illustrating a service discovery gateway, in accordance with yet another embodiment.

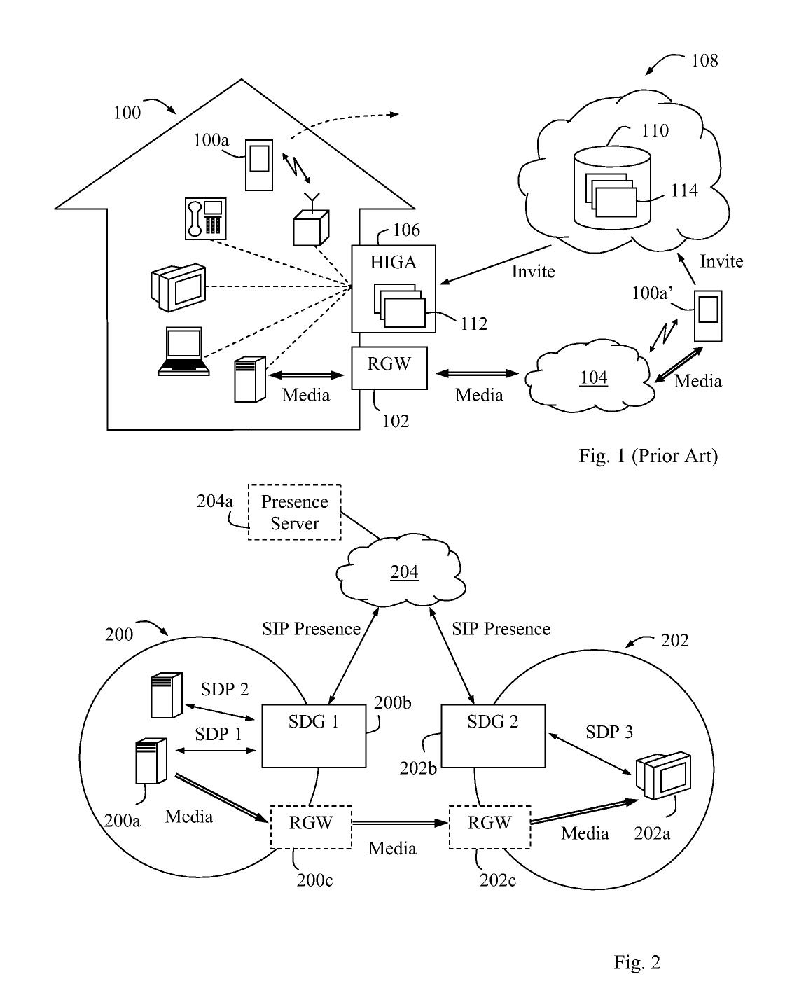

### DETAILED DESCRIPTION

Briefly described, the present invention can be used to enable remote discovery and utilisation of services and/or devices in one local network, from a device located in another opposite local network. The two local networks may use different internal service discovery protocols to communicate discovery information within each network, where the internal service discovery protocols may well be incompatible.

In this solution, the discovery process can be conducted between a device in one network and devices in the other opposite network, where the existing communication framework for presence services in an IMS network is used to convey discovery information in a generic format as “service presence information” between the two networks.

Conventionally, presence services make information related to a specific client available to other clients. Thus, presence data is stored in a presence server for providing such data to subscribing clients, and certain access rights can then also be enforced for different clients. The presence data of a client may typically relate to his/her status, device capabilities, geographic location, and other information such as interests, occupations, skills, characteristics, moods, etc.

This information is thus stored in the presence server based on publications received from the client or from the access network whenever any presence data for that client is introduced, updated, changed or deleted. According to common terminology in the field of presence services, a client that subscribes or requests for presence data is called the “Watcher”, and a client that publishes presence data is called the “Presentity”.

The “Presence Event Package for SIP” and the “Common Profile for Presence (CPP)” are extensions to SIP, enabling clients to publish and receive presence information as described above. Further, the SIP Presence Event Package has been adopted by the “Open Mobile Alliance (OMA)” and the 3GPP for use in IMS systems.

The SIP messages conventionally used in the presence context include “SIP publish” when the presentity sends presence data to the presence server for publication, “SIP subscribe” when the Watcher subscribes for presence data, and “SIP notify” when the presence server sends presence data to subscribing Watchers.

The present solution thus utilises the presence framework and the presence messages above can thus be used in a novel manner for conveying discovery information from one local network to another. Preferably, the service presence information may then be formatted according to the regular Presence Information Data Format (PIDF) normally used for communicating presence data.

In order to convey the discovery information over the IMS network between the two local networks during the discovery process, each local network comprises a gateway node adapted to communicate the discovery information with the opposite gateway node over the IMS network using the presence framework. This gateway node will be called the “Service Discovery Gateway, SDG” in the following description. For example, the SIP presence event package mentioned above can be used as the framework for conveying the discovery information between the service discovery gateways.

One or both of the service discovery gateways are preferably further adapted to translate discovery messages between whatever local service discovery protocols are used within the local networks, and a generic service discovery format to be embedded in the presence framework. In this description, the term “generic format” indicates that the format is understood and supported by both service discovery gateways.

The service discovery gateway in each local network is further adapted to communicate discovery information in the generic service discovery format over the IMS network, where the discovery information (e.g. service descriptions and device capabilities) is embedded in regular messages of the presence framework. Hence, each service discovery gateway effectively acts as a gateway between whatever service discovery protocol(s) used within the respective local network and the presence messages (e.g. according to SIP) for the communication through IMS.

For example, the regular presence message “SIP subscribe” can be used to convey a request from one local network to obtain discovery information about devices in the opposite local network. Further, the regular presence message “SIP notify” can be used to convey announced discovery information about one or more devices in one local network to the other opposite local network. In addition, if a presence server is used in the IMS network for collecting and distributing discovery information by means of the presence framework, the regular presence message “SIP publish” can be used to convey published discovery information to the presence server.

Effectively, in presence terms, the service discovery gateway at either local network will thus act as the presentity when providing discovery information to the opposite network, and as the watcher when requesting and obtaining discovery information from the opposite network.

One or more service discovery protocols are used in each local network that are dependent on the type of devices and services in the local network. Hence, plural different service discovery protocols may be used for different devices within the same local network, where the service discovery gateway can translate each of them into the generic format and vice versa. The two service discovery gateways in the local networks can basically be configured in the same way logically, i.e. to both provide and obtain discovery information remotely, but may be implemented practically in different ways.

For example, one service discovery gateway may be implemented in a HIGA or RGW in a residential local network (e.g. using a service discovery protocol based on UPnP, Zigbee or IrDA), while the other service discovery gateway in the opposite network could be implemented in a mobile user terminal temporarily being present in a local ad hoc network (e.g. using a Bluetooth-based service discovery protocol). In that case, the mobile user terminal should include an IMS client and functionality for translation between service discovery protocols, in order to act as a service discovery gateway and to communicate with the IMS network.

The mobile user terminal may thus have the functionality of a HIGA in order to set up IMS sessions on behalf of non-IMS devices in the ad hoc network, which is referred to as “PIGA Portable IMS Gateway”. By implementing a PIGA and a service discovery gateway on a mobile terminal, it will also be possible to discover services and devices in such ad hoc networks, and provide information to remote service discovery gateways, or to an IMS-centric presence server, to publish and make such services available to other local networks.

The watching service discovery gateway in one local network may use the obtained discovery information to establish a service usage session with a device in the opposite local network. Both nodes must support the generic service description format to utilise the service information. The Service Usage protocol for a media session between two devices in opposite local networks (e.g. HTTP streaming, RTSP streaming, FTP, etc.) depends on the particular service and/or application, and it must be supported by both devices.

In FIG. 2, an exemplary scenario and process is illustrated for conveying discovery information between devices in a first local network 200 and a device in an opposite second local network 202 by means of a presence framework over an IMS network 204, using a service discovery gateway at either local network. In this example, a media player 202a in the second network 202 will fetch media stored at a media server 200a in the first network, in order to present the media at the second network.

The local networks 200, 202 can be considered as limited service “islands” where different services available on individual local devices can be shared between the local devices within each service island. In this description, the term local network implies such a service island.

Thus, the first network 200 comprises a first service discovery gateway 200b and possibly an RGW 200c for communication of media outside the network 200, whereas the second network 202 comprises a second service discovery gateway 202b and possibly an RGW 202c as well. Each network 200, 202 must also have access to an IMS client, e.g. in a HIGA or an IMS user terminal, for communication over the IMS network 204, although it is assumed here that the IMS client resides logically in the shown service discovery gateways 200b, 202b.

As indicated in the figure, the first local network 200 uses one or more internal service discovery protocols SDP1, SDP2 valid within the network 200 for conducting discovery procedures. On the other hand, the second local network 202 uses another internal service discovery protocol SDP3 valid within the network 202 that may well be different and incompatible to the ones used in the first network 200, but not necessarily so. A discovery procedure can be conducted across the two local networks 200, 202 as described below.

The service discovery gateway 202b in the second network 202, using the address sdg2@yyy.com, may issue a request for discovery information from the opposite network 200 embedded in the presence framework. The discovery information request can be sent in the form of a SIP subscribe message, effectively subscribing to “service presence events” from the service discovery gateway 200b in network 200. The SIP subscribe message could then be configured as:

### Message Example 1

SUBSCRIBE sip:sdg1@xxx.com SIP/2.0
From: <sip:sdg2@yyy.com>
To: <sip:sdg1@xxx.com>
Event: presence

### Content-Length: 0

It is not necessary to further include a body in this message, although optional filters for the requested service presence information may be specified in the message. The SIP subscribe message above is thus directed to the service discovery gateway 200b in the opposite network 200, using the address sdg1@xxx.com, and the discovery process is therefore conducted “peer-to-peer”, i.e. more or less directly between the two service discovery gateways 200b, 202b.

As mentioned above, it also possible to involve an intermediate presence server in the IMS network to collect and distribute service presence information between various local networks. Thus, using a presence server in the IMS network will basically enable discovery procedures across more than just two local networks. In this case, the presence server 204a has the address sps@xyz.com, and a SIP subscribe message thereto from service discovery gateway 202b could then be configured as:

### Message Example 2

SUBSCRIBE sip:sps@xyz.com SIP/2.0
From: <sip:sdg2@yyy.com>
To: <sip:sps@xyz.com>
Event: presence

### Content-Length: 0

The SIP subscribe message above is thus directed to the presence server 204a, and the discovery process is therefore considered to be “IMS-centric”. As in the peer-to-peer case, it is not necessary to further include a body in this message.

Further, if the IMS-centric solution is used, the service discovery gateway 200b in the first network 200 can publish discovery information on devices in network 200 by sending a SIP publish message to presence server 204a, after having obtained the discovery information in a discovery process locally within network 200. First, the service discovery gateway 200b translates the locally obtained discovery information from a local service description format, if necessary, into a generic service description format understood by both service discovery gateways 200b, 202b. However, in some cases, the local discovery information can be embedded in the presence message without translation if already in a service description format understood by both networks, i.e. generic format, and the translation is not necessary. The SIP subscribe message from service discovery gateway 200b in the IMS centric case could then be configured as:

Message example 3
PUBLISH sip:sps@xyz.com SIP/2.0
From: <sip:sdg1@yyy.com>
To: <sip:sps@xyz.com>
Event: presence
Content-Length: entity-body-length
Content type: application/pidf+xml
<xml version=“1.0”>
followed by a body containing the published discovery information according to the generic service discovery format, in this example in the XML (Extensible Mark-up Language) format. The discovery information is thus handled as service presence information according to the presence framework, in particular the Presence Event Package for SIP. The service presence information may then be formatted in line with the presence information data format (PIDF).

The SIP publish message above is thus directed to the presence server 204a in the IMS network 204 which then will distribute the published discovery information further by sending a SIP notify message to the subscribing service discovery gateway 202b in the second network 202. The SIP notify message from presence server 204a in the IMS centric case could then be configured as:

### Message Example 4

NOTIFY sip:sdg2@xxx.com SIP/2.0
From: <sip:sps@xyz.com>
To: <sip:sdg2@xxx.com>
Event: presence
Content-Length: entity-body-length
Content type: application/pidf+xml
<xml version=“1.0”>
followed by a body containing the discovery information in the XML format as generic discovery information.

On the other hand, if the peer-to-peer solution is used, i.e. not involving the presence server 204a, the service discovery gateway 200b in the first network 200 can send a SIP notify message with discovery information directly to the subscribing service discovery gateway 202b in response to receiving the SIP subscribe message of example 1 above, and after having obtained the discovery information locally within network 200. The SIP notify message from service discovery gateway 200b in the peer-to-peer case could then be configured as:

### Message Example 5

NOTIFY sip:sdg2@xxx.com SIP/2.0
From: <sip:sdg1@yyy.com>
To: <sip:sdg2@xxx.com>
Event: presence
Content-Length: entity-body-length
Content type: application/pidf+xml
<xml version=“1.0”
likewise followed by a body containing the discovery information in the XML format as generic service discovery information.

In either case, the service discovery gateway 202b has now finally received the discovery information regarding devices in the first network 200, either directly from the opposite service discovery gateway 200b or from the presence server 204a. That information can then be provided to any device in the second network 202 in a local discovery process, e.g. after translating the discovery information received in the generic format into some valid local service discovery protocol, if necessary. Further, if the status of a service is changed in network 200, service discovery gateway 200b (the presentity) can notify service discovery gateway 202b (the watcher) about the change as a “service presence event”, e.g. depending on the events service discovery gateway 202b has subscribed to.

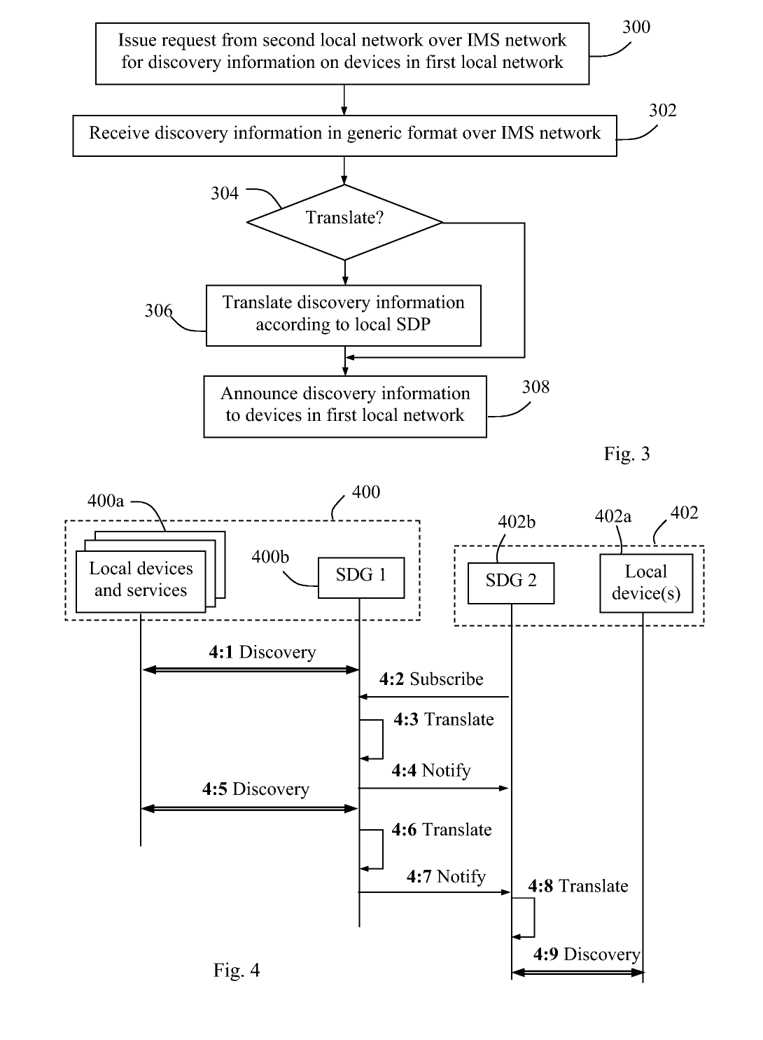

A procedure for enabling remote discovery of services and devices in a first local network from a location within a second local network, will now be described with reference to the flow chart in FIG. 3. The shown steps are executed by the service discovery gateway in the second local network.

In a first step 300, a request for discovery information on devices and services in the first local network is issued from the service discovery gateway in the second local network, over an IMS network using the presence framework. The discovery information request may be sent as a SIP subscribe message as described above for FIG. 2, either directly to a corresponding service discovery gateway in the opposite first local network or to an intermediate presence server in the IMS network, in order to subscribe to service presence information and events according to the presence framework.

In a next step 302, discovery information is received in a generic format over the IMS network, in response to the discovery information request. As explained above for FIG. 2, the discovery information may be received either directly from the service discovery gateway in the first local network in the peer-to-peer case, or from a presence server in the IMS network in the IMS-centric case. The discovery information request may be received as a SIP notify message as described above for FIG. 2.

In a further step 304, it is determined whether it is necessary to translate the received discovery information from the generic format into a local service description format according to a local service discovery protocol used in the second network for service discovery procedures. If necessary, the discovery information is first translated in a following step 306 into a local service description format valid for conducting local discovery procedures with at least one device in the second network. The translated discovery information is then finally provided to devices in the first local network during a regular local discovery procedure in a step 308. If it is not necessary in step 304 to translate the discovery information received in the generic format, the process can move directly to step 308 of providing the discovery information to devices in the first local network.

An exemplary messaging flow for remote discovery of services and devices in a first local network from a location within an opposite second local network, based on the above-described peer-to-peer method, will now be described with reference to the signalling diagram in FIG. 4. It should be noted that the skilled person will understand that each shown signalling step in the figure may represent one or more specific messages transferred back and forth according to the used protocol(s).

In a first step 4:1, a discovery process is at some point conducted within the first local network 400 involving a plurality of devices and services 400a and a service discovery gateway 400b, such that service discovery gateway 400b obtains or collects discovery information on the devices and services 400a. A local service discovery protocol is used in the discovery process and the discovery information obtained by service discovery gateway 400b may not be understood at the opposite network 402.

The second local network 402 comprises at least one device 402a and another service discovery gateway 402b. In a next step 4:2, service discovery gateway 402b sends a SIP subscribe message according to the presence framework directly to service discovery gateway 400b, as a request for discovery information on devices and services in the first local network 400. If necessary, service discovery gateway 400b translates, in a step 4:3, the discovery information obtained in step 4:1 is translated into a generic format that is understood by both service discovery gateways 400b, 402b.

Service discovery gateway 400b then provides the sends a SIP notify message in a following step 4:4, containing the translated discovery information, in response to the SIP subscribe message.

Then, at some later point sooner or later, another discovery process may take place within the first local network 400 in a further shown step 4:5, e.g. according to some predetermined scheme or whenever any device or service therein has been added, removed or modified, to update the discovery information. Since service discovery gateway 402b subscribes to service discovery information of network 400, service discovery gateway 400b may translate the newly obtained discovery information, in a further step 4:6, and send the translated and updated discovery information to service discovery gateway 402b, in another step 4:7.

After either of steps 4:4 and 4:7, service discovery gateway 402b is able to conduct a discovery process locally within network 402 in order to provide the received discovery information to at least one device in the second local network, using a local service discovery protocol valid within the second local network 402. Thus, service discovery gateway 402b may need to translate the received discovery information, as shown in step 4:8, from the generic format into a local service description format valid in network 402, before conducting a discovery process involving at least one device 402a in network 402, in a final illustrated step 4:9.

The example of FIG. 4 is thus based on the above-described peer-to-peer method where the management of “service presence events” is handled between the service discovery gateways 400b, 402b, although not involving any IMS network functions such as a presence server. In presence terms, the service discovery gateway 400b thus acts as a “service presence event handler”. However, the SIP signalling between the service discovery gateways 400b, 402b will naturally pass over a suitable session control node in the IMS network, not shown. In particular, the IMS network can be used for identification, authentication, access control as well as addressing and mobility support of the end-to-end SIP messages.

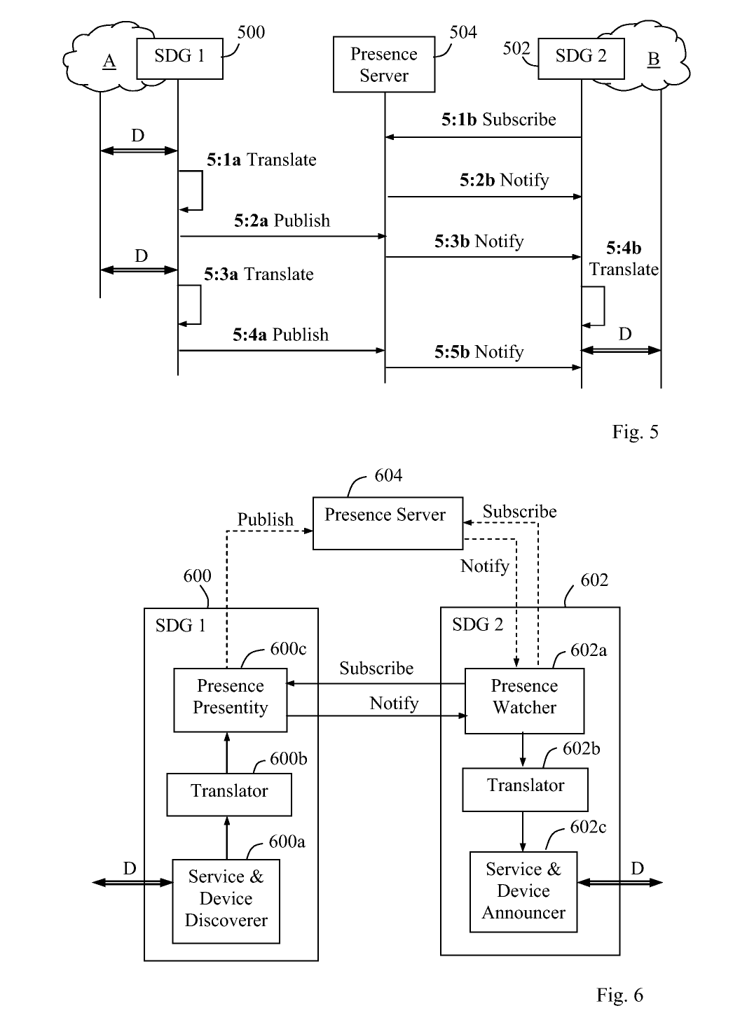

Another exemplary procedure and messaging flow for remote discovery of services and devices, based on the above-described IMS centric method, will now be described with reference to the signalling diagram in FIG. 5. Again, any signalling step shown in the figure may represent one or more specific messages depending on the used protocol(s).

Thus, two opposite service discovery gateways 500, 502 in a first and a second local network A and B, respectively, are both adapted to communicate with a presence server 504 in an IMS network, using SIP signalling according to the presence framework, to convey discovery information in a generic format understood by both service discovery gateways 500, 502. In this example, the shown process can be seen as having two parallel parts: one part marked “a” for making published discovery information from the first network A available in the presence server 504, and another part marked “b” for providing discovery information to the second network B.

The two-way arrows D in the figure generally represent a discovery process conducted locally within the local networks A and B, respectively. In a first step 5:1a, service discovery gateway 500 translates discovery information obtained in a discovery process D into the generic format, and sends a SIP publish message in a following step 5:2a, containing the translated discovery information, to presence server 504. The following steps of discovery D, translation 5.3a and sending the SIP publish message 5:4a are basically a repetition of the previous steps whenever the discovery information is updated. In this way, the presence server 504 will maintain discovery information on the first local network that is up-to-date.

The other part “b” of the process includes that service discovery gateway 502 sends a SIP subscribe message to presence server 504 in a step 5:1b, effectively requesting discovery information on devices and services in the first local network A. If service discovery gateway 500 has published any discovery information previously, the presence server 504 will send a SIP notify message in a step 5:2b containing the current discovery information in the generic format, e.g. according to the message example 4 given above.

In due time, the presence server 504 may send further SIP notify messages, as exemplified by steps 5:3b and 5:5b, whenever the discovery information is updated by receiving SIP publish messages from service discovery gateway 500, as in steps 5:2a and 5:4a. In order to conduct a discovery process within the second local network B, the service discovery gateway 502 may eventually translate the obtained discovery information, as shown in a step 5:4b, into a local service description format according to a local service discovery protocol used in the second network B for service discovery procedures. A local discovery procedure D can then be conducted within the second network B, as indicated by the two-way arrow.

It should be noted that the process in part “a” of discovery D, translation (steps 5.1a, 5:3a) and sending the SIP publish message (steps 5:2a, 5:4a) can basically be executed regardless of the activities in part “b”, i.e. only dependent on when the discovery information is updated. However, SIP notifying messages (e.g. steps 5:3b, 5:5b), may be sent from presence server 504 in response to receiving the SIP publish messages (e.g. steps 5:2a, 5:4a). Accordingly, after step 5:5b, a further translation step, not shown, may be executed in service discovery gateway 502 followed by another discovery process, and so forth.

The example of FIG. 5 is thus based on the above-described IMS centric method where the management of “service presence events” is handled by the presence server 504, effectively acting as a “service presence event handler” or “service presence event management server” in the IMS network.

One advantage of using an intermediate presence server for remote discovery, is generally that published discovery information of one presentity local network can easily be made available to any number of other watcher local networks, using the existing presence handling functionality. Different filters may also be applied for different watchers in the same manner as in regular presence procedures. Moreover, a presence server in an IMS network is generally deemed more powerful with respect to processing and storing capacity, as compared to resource-limited gateways and devices in typically small local networks.

Next, a more detailed description will be given of two service discovery gateways in opposite local networks, adapted to conduct remote discovery basically in the manner described above, with reference to the block diagram shown in FIG. 6. It should be noted that FIG. 6 illustrates different functional units purely logically, and the skilled person will be able to implement these functions in practice in any suitable manner, e.g. by means of hardware and software. As in the previous examples above, a first service discovery gateway 600 of a first local network, acting as a presentity, provides discovery information remotely to a second service discovery gateway 602 of a second local network, acting as a watcher, over an IMS network and using messages of the presence framework.

The first service discovery gateway 600 comprises a service and device discoverer 600a adapted to obtain discovery information by conducting a discovery process D within its local network, not shown. A translator 600b is adapted to translate the discovery information obtained by the service and device discoverer 600a, if necessary, from a local service description format used in the first network into a generic format understood by both service discovery gateways 600, 602.

Service discovery gateway 600 further comprises a functional unit called the “presence presentity” 600c adapted to send the translated discovery information according to the presence framework, either in a SIP notify message directly to the opposite service discovery gateway 602 (the peer-to-peer case) or in a SIP publish message to an intermediate presence server 604 in the IMS network (the IMS centric case).

Further, the second service discovery gateway 602 comprises a functional unit called the “presence watcher” 602a adapted to receive the discovery information in the generic format in a SIP notify message, either directly from the presence presentity 600c of the opposite service discovery gateway 600 (the peer-to-peer case), or from the presence server 604 (the IMS centric case). A translator 602b is adapted to translate the discovery information received by the presence watcher 600a, if necessary, from the generic format into a local service description format used in the second local network.

The second service discovery gateway 602 further comprises a service and device announcer 602c adapted to announce the obtained discovery information to one or more local devices by conducting a discovery process D within the second local network, not shown. The transport of discovery information over the shown functional units, i.e. initially from the service and device discoverer 600a and finally to the service and device announcer 602c, is generally illustrated by the arrows in FIG. 6.

The above-described functions in the two opposite service discovery gateways 600, 602 are illustrated here only for the case when discovery information from the first local network is presented to the second local network. However, each service discovery gateway 600, 602 may in practice comprise all the shown functional units for presenting discovery information the other way round, i.e. from the second local network to the first local network, to enable remote service discovery in both directions.

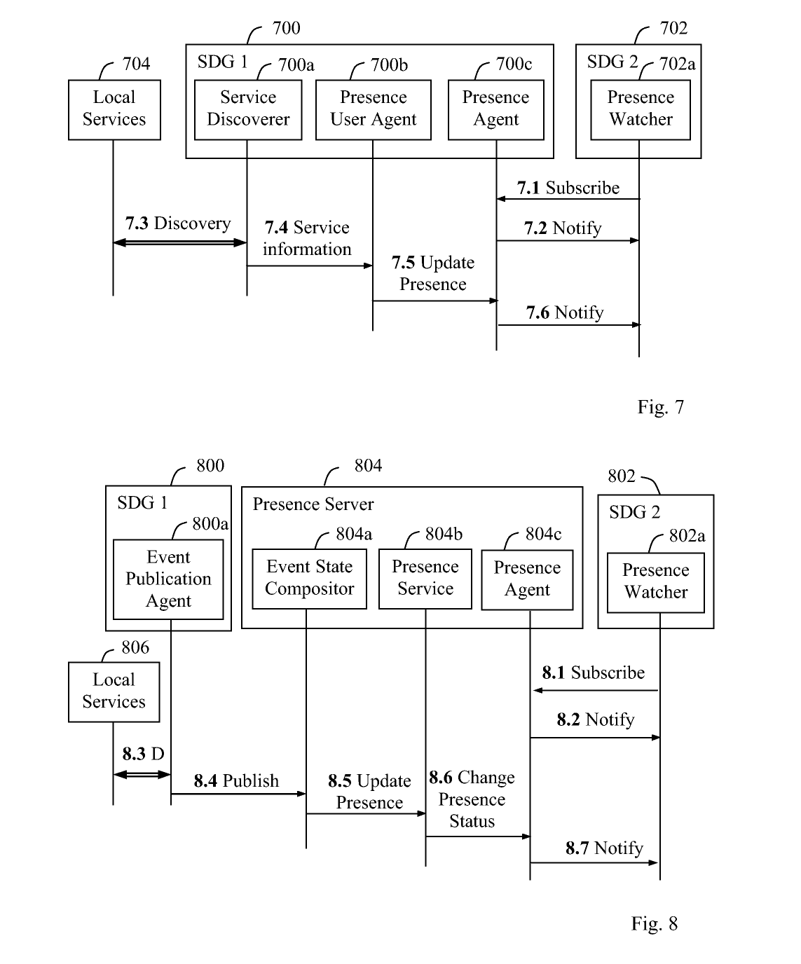

FIGS. 7 and 8 illustrate examples of possible implementations of the functional flow in the above-described cases using the peer-to-peer and IMS centric methods, respectively. In FIG. 7, a first service discovery gateway 700 in a first local network thus provides discovery information directly to an opposite second service discovery gateway 702 in a second local network. In a first shown step 7.1, a presence watcher 702a in the second service discovery gateway 702 sends a SIP subscribe message to the opposite service discovery gateway 700, requesting for discovery information.

The SIP subscribe message is received by a presence agent 700c which may immediately respond by sending a SIP notify message back to presence watcher 702a, in a next step 7.2, containing any discovery information previously obtained in the second local network. The presence agent 700c is thus adapted to communicate presence messages of the presence framework with the presence watcher 702a.

In a further step 7.3, a discovery procedure is conducted within the first local network where a service discoverer 700a in the first service discovery gateway 700 obtains discovery information from local service nodes 704. In this implementation, the service discoverer 700a is also adapted to translate the service description format used by each local service node into the generic service description format understood by the opposite service discovery gateway 702, although not shown here as a separate step.

The service information from the discovery process is then conveyed from service discoverer 700a to a presence user agent 700b in the service discovery gateway 700, in a step 7.4. The presence user agent 700b is adapted to prepare and manipulate presence information on behalf of a presentity, according to current standards. In this case, the presentity is actually the service discoverer 700a, and the presence information is the description (in SDP format) of a service. For example, the manipulation by presence user agent 700b may take care that this service information is transferred into a format that complies with PIDF.

Accordingly, presence user agent 700b conveys the prepared presence information to presence agent 700c, in a further step 7.5. Finally, triggered by this event of a new service presence information, presence agent 700c sends a SIP notify message to any subscribers (i.e. presence watchers) including presence watcher 702a, containing the discovery information in the generic format, over the IMS network using the presence framework, in a last step 7.6.

In the IMS centric case illustrated in FIG. 8, a first service discovery gateway 800 in a first local network provides discovery information to an opposite second service discovery gateway 802 in a second local network indirectly via a presence server 804. In this case, the first service discovery gateway 800 has omitted the presence agent 700c and instead comprises an event publication agent 800a adapted to send published service presence information to the presence server 804. The first service discovery gateway 800 also comprises a service discoverer and a presence user agent just as in the previous example, although not shown here for simplicity. Thus, it is assumed that discovery information obtained in a local discovery procedure D is provided to the event publication agent 800a in the same manner as to the presence agent 700c in the example of FIG. 7, and description thereof will not be repeated here.

In a first shown step 8.1, a presence watcher 802a in the second service discovery gateway 802 sends a SIP subscribe message to a presence agent 804c in presence server 804, which may immediately send a SIP notify message back to presence watcher 802a, in a next step 8.2, as similar to steps 7.1 and 7.2 in FIG. 7. The presence agent 804c is thus adapted to communicate presence messages with the presence watcher 802a.

A further step 8:3 illustrates that a discovery procedure is conducted within the first local network where a service discoverer, not shown, in the first service discovery gateway 800 obtains discovery information from local service nodes 806. After receiving the discovery information from a presence user agent, obtained and translated (if necessary) by the service discoverer, event publication agent 800a sends the discovery information as service presence information in a SIP publish message to presence server 804, in a following step 8.4. In this step, the published service presence information is received by an event state compositor 804a in the presence server, which is adapted to store received published presence information at a designated presence service. Thus, the received discovery information is stored as updated presence information in a presence service unit 804b in presence server 804, in a next step 8.5.

The presence service unit 804b then informs the presence agent 804c that the presence status is changed, in a step 8.6. Finally, presence agent 804c sends a SIP notify message containing the updated discovery information to presence watcher 802a in the second service discovery gateway 802, in a last step 8.7.

The above-described functions in the service discovery gateway can be utilized in several ways, e.g. by specific applications that run on any type of devices in a local network. By way of example, two different use cases that can be implemented “on top of” the service discovery gateway will now be described, although other use cases are also possible within the scope of the present invention.

In a first example, the service discovery gateway SDG can be integrated with a service control application in a single user device in a local network, such as a mobile phone or an STB. For example, the SDG functions may be implemented in a local device also having a HIGA functionality, i.e. PIGA. An application (preferably having a dedicated logic and Graphical User Interface GUI) on the SDG device may utilise the above-described SDG functions, so that the user can actively control the discovery and usage of both local and remote services. Thereby, the user of the device can select an address of a remote local network (e.g. the user's home network while travelling) when located in a visited local network and discover services at the remote network (e.g. content in a media server). Moreover, the user can search for devices (e.g. a suitable media player) in a visited local network environment, and then initiate a service usage session for a selected local device with a device in the remote network (e.g. a media streaming session between a remote media server and a local media player), using the above-described SDG functions.

In a second example, an SDG1 in a first local network acts as a presence watcher towards an SDG2 in a second local network. Thereby, SDG1 effectively acts as a “virtual” service provider of a service 2A from the second local network, transparently to the devices in the first local network. A control application with GUI could be provided e.g. by a service 1B in the first local network, and SDG1, utilizing the service presence information from SDG2, would appear as service 2A.

As another example, service 1A in the first local network (which could be a media provision service with control GUI) could search for available media clients in the first local network, and SDG1 could transparently appear as a virtual service 2A (which would be a media client) from the second local network. Hence, the remote media client (i.e. service 2A in network 2) could be utilized by the service 1A as if it were present within the same local network.

The above-described functions in the service discovery gateway SDG may also be utilised in the context of remote control and management of buildings. In the future, various equipment in private buildings can be connected to local home networks to support, e.g., the control of heating, ventilation, air conditioning, lightning and monitoring cameras. To control a building remotely, a remote control client, implemented in a PIGA, can connect to the SDG in the local network of that building (e.g. implemented within a HIGA) through the IMS communication infrastructure.

By using the present invention according to any of the above-described embodiments, the following advantages and improvements may be obtained:

By using the network infrastructure of IMS and presence framework as a generic transport means for remote discovery, local services can be provided and utilized across service islands in different local networks, even when various different device-specific service discovery protocols are used within the local networks. Thereby, a multitude of use cases and applications can be supported in a flexible and extensible way.

If an IMS centric presence server is used for the management of presence events in the remote discovery, the SDP traffic (in particular between the IMS network and the presentity SDG) can be optimised, and the end-to-end traffic between watcher SDGs and presentity SDGs can be minimized. Further, the generic format for service description may include metadata allowing the presence server to cache frequently used information etc.

Furthermore, when utilizing the presence framework in the manner described above, owners of services and content in a local network can define particular access rights to specific services and content in the local network, for users and user groups when located in other local networks. Also, the underlying IMS identification and authorization mechanisms can be used to control the services and content access.

When the “Presence Event Package for SIP” is used to exchange the discovery information through the IMS infrastructure by means of regular SIP messages, the inherent IMS/SIP addressing and mobility support can also be utilized.

While the invention has been described with reference to specific exemplary embodiments, the description is in general only intended to illustrate the inventive concept and should not be taken as limiting the scope of the invention. Although the concepts of IMS, HIGA, UPnP and SDP have been used when describing the above embodiments, any other similar suitable standards and network elements may basically be used for enabling the discovery process across local networks as described herein. The present invention is generally defined by the following independent claims.

1. A method of enabling remote discovery of services and devices in a first local network from a location within a second local network, comprising the following steps executed by a service discovery gateway in the second local network:
issuing a request for discovery information on the devices in the first local network, wherein the request is sent embedded in a presence subscribe message over an IMS network,
receiving discovery information in a generic format embedded in a presence notify message over the IMS network in response to said request, wherein the received discovery information has been collected by a service discovery gateway in the first local network in a discovery process using a local service discovery protocol valid within the first local network, and
announcing the received discovery information to at least one device in the second local network, using a local service discovery protocol valid within the second local network.

2. A method according to claim 1, wherein the discovery information is translated from the generic format into a local format supported by the second local network, before being announced in the second local network.

3. A method according to claim 1, wherein the request for discovery information is sent to the service discovery gateway in the first local network, and the discovery information is received as a response from that service discovery gateway.

4. A method according to claim 1, wherein the request for discovery information is sent to a presence server in the IMS network, and the discovery information is received as a response from that presence server.

5. A method according to claim 4, wherein the presence server has received said collected discovery information in a presence publish message from the service discovery gateway in the first local network.

6. A method according to claim 1, wherein the second local network is an ad hoc network and the service discovery gateway in the second local network is implemented in a user device acting as a multimedia gateway to access the IMS network on behalf of other devices in the ad hoc network.

7. A method according to claim 6, wherein a portable IMS gateway PIGA is implemented in said user device.

8. A service discovery gateway for conducting remote discovery of services and devices in a first local network from a location within a second local network, the service discovery gateway being connected to the second local network, comprising:
a presence watcher unit for issuing a request for discovery information on the devices in the first local network, wherein the request is sent embedded in a presence subscribe message over an IMS network, and receiving discovery information embedded in a presence notify message over the IMS network in response to said request, wherein the received discovery information has been collected by a service discovery gateway in the first local network using a local service discovery protocol valid within the first local network, and
an announcing unit for announcing the received discovery information to at least one device in the second local network, using a local service discovery protocol valid within the second local network.

9. A service discovery gateway according to claim 8, further comprising a translator for translating the discovery information from the generic format into a local format supported by the second local network, before being announced in the second local network.

10. A service discovery gateway according to claim 8, wherein the presence watcher unit sends the request for discovery information to the service discovery gateway in the first local network, and receives the discovery information as a response from that service discovery gateway.

11. A service discovery gateway according to claim 8, wherein the presence watcher unit sends the request for discovery information to a presence server in the IMS network, and receives the discovery information as a response from that presence server.

12. A service discovery gateway according to claim 8, wherein the second local network is an ad hoc network and the service discovery gateway in the second local network is implemented in a user device acting as a multimedia gateway to access the IMS network on behalf of other devices in the ad hoc network.

13. A service discovery gateway according to claim 12, wherein a portable IMS gateway PIGA is implemented in said user device.

14. A method of enabling remote discovery of services and devices in a first local network from a location within a second local network, comprising the following steps executed by a service discovery gateway in the first local network:
collecting discovery information of said services and devices in the first local network in a discovery process using a local service discovery protocol valid within the first local network, and
providing the collected discovery information in a generic format embedded in a presence message over an IMS network, thereby enabling a service discovery gateway in the second local network to announce said discovery information to at least one device in the second local network, using a local service discovery protocol valid within the second local network.

15. A method according to claim 14, wherein the collected discovery information is obtained in a local format and translated into said generic format, before being provided over the IMS network.

16. A method according to claim 14, wherein the presence message is sent as a presence notify message to the service discovery gateway in the second local network.

17. A method according to claim 14, wherein the presence message is sent as a presence publish message to a presence server in the IMS network.

18. A service discovery gateway for enabling remote discovery of services and devices in a first local network from a location within a second local network, the service discovery gateway being connected to the first local network, comprising:
a discovery unit for collecting discovery information of said services and devices in the first local network in a discovery process using a local service discovery protocol valid within the first local network, and
a presence presentity unit for providing the collected discovery information in a generic format embedded in a presence message over an IMS network, thereby enabling a service discovery gateway in the second local network to announce said discovery information to at least one device in the second local network, using a local service discovery protocol valid within the second local network.

19. A service discovery gateway according to claim 18, further comprising a translator for translating the discovery information obtained in a local format into said generic format, before being provided over the IMS network.

20. A service discovery gateway according to claim 18, wherein the presence presentity unit sends the presence message as a presence notify message to the service discovery gateway in the second local network.

21. A service discovery gateway according to claim 18, wherein the presence presentity unit sends the presence message as a presence publish message to a presence server in the IMS network.

22. A presence server in an IMS network, for enabling remote discovery of services and devices in a first local network from a location within a second local network, comprising:
an event state compositor for receiving discovery information on devices in the first local network, in a generic format embedded in a presence publish message from a service discovery gateway connected to the first local network, and
a presence agent for receiving a request for said discovery information, embedded in a presence subscribe message, from a service discovery gateway connected to the second local network, and sending said discovery information embedded in a presence notify message to the service discovery gateway in the second local network in response to said request, thereby enabling the service discovery gateway in the second local network to announce said discovery information to at least one device in the second local network, using a local service discovery protocol valid within the second local network.
